(19) United States
(12) Patent Application Publication
(10) Pub. No.: US 2010/0212126 A1
(43) Pub. Date: Aug. 26, 2010

(54) Method for Manufacturing a Transmitter/Receiver and Apparatus Obtained by Means of Such a Method

(76) Inventor: Reinier Antonius Parie, Ridderkerk (NL)

Correspondence Address: JACOBSON HOLMAN PLLC, 400 SEVENTH STREET N.W., SUITE 600, WASHINGTON, DC, 20004, US

(21) Appl. No.: 12/225,376

(22) PCT Filed: Mar. 20, 2007
(86) PCT No.: PCT/IN2007/050117

§ 371 Date: Apr. 27, 2010

(30) Foreign Application Priority Data
Mar. 20, 2006 (NL) 1031409

(51) Int. Cl. G10K 11/18

(52) U.S. Cl. 29/25.35; 29/896.2; 29/594

(57) ABSTRACT

A method for manufacturing a transmitter/receiver (1) for transmitting/receiving acoustic waves, which method comprises at least the following steps: placing a transmitting and/or receiving layer (10) in or on an inner housing (2) in a manner such that a side of the inner housing is at least virtually sealed off by the transmitting and/or receiving layer, providing at least a first material (16) in a space enclosed by the inner housing, which space is adjacent to the transmitting and/or receiving layer, providing an outer housing (4) around an inner housing, which outer housing surrounds the inner housing at least partly after provision, and providing a second material (20) between the inner housing and the outer housing, characterized in that upon provision of the second material, through pouring, the second material runs in a vacuum, between the inner housing and the outer housing for the purpose of manufacturing a fixed connection between the inner housing and the outer housing.

The invention relates to a method for manufacturing a transmitter/receiver for transmitting/receiving acoustic waves, which method comprises at least the following steps:
a. placing a transmitting and/or receiving layer in or on an inner housing in a manner such that a side of the inner housing is at least virtually sealed off by the transmitting and/or receiving layer;
b. providing at least a first material in a space enclosed by the inner housing and the outer housing, which space is adjacent to the transmitting and/or receiving layer;
c. providing an outer housing around the inner housing, which outer housing encloses the inner housing at least partly after provision; and
d. providing a second material between the inner housing and the outer housing.

The invention also relates to an apparatus obtained by means of such a method.

Such a method is known per se. A drawback of the transmitter/receiver manufactured with the aid of this method is the limited resistance the transmitter/receiver has against external pressure, which restricts the technical field of use of the transmitter/receiver. The fact is that the transmitter/receiver can only be used in a fluid under a limited pressure.

An object of the invention is to more adequately fill the space between the inner housing and the outer housing with a material used for attaching the inner housing and the outer housing to each other.

This object is achieved with the aid of the invention, which is characterized in that, upon provision of the second material, through pouring, the second material runs in a vacuum between the inner housing and the outer housing for the purpose of manufacturing a fixed connection between the inner housing and the outer housing. For use as second material, a resin such as epoxy qualifies.

As the pouring of the second material takes place in a vacuum, the space between the inner housing and the outer housing is filled better, so that, between the inner housing and the outer housing, a good back pressure can be applied against the external pressure. Upon pouring in a vacuum, any gas pollutions that may be present simply leave the second material, which also contributes to the capacity of applying a good back pressure. If inclusions of gas were to be present in the cured material, the material would not be resistant to these high pressures because in that case, the material can be compressed and will deform and/or tear, with all associated negative consequences.

In a further embodiment of the method according to the invention, the method is characterized in that, when the second material runs between the inner housing and the outer housing, the second material has a flowing condition and then changes into a binding condition for the purpose of manufacturing a fixed connection between the inner housing and the outer housing. An advantage thereof is that a material can be utilized that, on the one side, i.e. in the flowing condition, can reach difficultly accessible cavities and, on the other side, i.e. in the binding condition, can obtain a condition with a high degree of pressure resistance and/or binding capacity.

It is also possible that step d also comprises the pouring of the second material into at least a part of the inner housing and the subsequent curing of the second material, with step d being carried out after step b. This has as an advantage, inter alia, that the same materials are utilized, which is advantageous when the transmitter/receiver is subject to great temperature variations.

Further, the latter embodiment can be characterized in that, upon pouring the second material, the inner housing overflows in a manner such that the second material also runs between the inner housing and the outer housing, while step d is carried out after steps .b and c. Here, the second material is provided not only between the inner housing and the outer housing, but also in the inner housing. This has as an advantage that the second material can be provided in a relatively simple manner, as no specific, exact amount of second material to be poured for the purpose of the space between the inner housing and the outer housing needs to be taken into account. Also, pouring into the inner housing is simpler than, for instance, pouring directly between the inner housing and the outer housing because, as a rule, there is less space present for pouring in between the inner housing and the outer housing than in the inner housing. Filling the inner housing results in further increase of the resistance against external pressure.

It is further preferred that, preferably before carrying out step b, the method comprises the step of vibrating the first material for, removing polluting gases from the first material. The less gas is present in the first material, the greater the resistance of the apparatus is against external pressure.

Further, an embodiment of the method according to the invention is possible, characterized in that, after carrying out step b and before carrying out step d, the method further comprises the following step: f. positioning the inner housing, the outer housing and the transmitting and/or receiving layer relative to a top surface of the first material such that the top surface includes an angle with the transmitting and/or receiving layer. Thus, resonance phenomena are prevented, because the path length of optionally standing waves in the first material differs at different locations. A clever way of carrying out this step may, for that matter, also comprise the curing of the first material while the top surface includes the angle mentioned.

A special embodiment of the method according to the invention is further characterized in that the method comprises the following step: wiring the transmitting and/or receiving layer by means of wiring for controlling the transmitting and/or receiving layer and/or passing on received signals from the transmitting and/or receiving layer.

This wiring may comprise providing at least a first wire prior to carrying out steps b and d, which first wire is attached to a side of the transmitting and/or receiving layer that is adjacent to the space enclosed by the inner housing and the outer housing, and which extends through this enclosed space in a direction away from the transmitting and/or receiving layer as far as outside this space.

However, wiring may also comprise providing at least one second wire prior to carrying out steps b and d, which second wire is attached to a side of the transmitting and/or receiving layer which is on a side facing away from the space enclosed by the inner housing and the outer housing. Here, it is preferred that the second wire is provided in step c and before step d, in a manner such that it extends further between the inner housing and the outer housing.

To protect the transmitting and/or receiving layer even better from undesired external influences, one embodiment of the method according to the invention is characterized in that the method also comprises applying a layer to the transmitting and/or receiving layer on a side facing away from the space enclosed by the inner housing and the outer housing. The layer may be a lambda layer. The layer may, for instance, have a thickness that corresponds to a quarter of waves to be transmitted or to be received by the apparatus. Such a layer is often called a ¼ lambda layer. Applying such a layer preferably takes place in a vacuum, so that no undesired gases, such as air, are present in the epoxy. After this, the epoxy can cure and the layer can be finished by sanding.

A piezo crystal is particularly suitable for converting electric signals into acoustic signals and vice versa. That is why such a piezo crystal is particularly suitable as a transmitting and/or receiving layer.

It is possible to carry out the method according to the invention in a manner such that the transmitting and/or receiving layer is provided on a supporting surface before step a is carried out. Transmitting and/or receiving layers used for the invention are typically of a type having, in itself, little resistance to external influences. Such a supporting surface can therefore serve to prevent damage of the transmitting and/or receiving layer. The transmitting and/or receiving layer can simply be provided on the supporting surface with the aid of a tape. Here, for instance a tape with a self-adhesive surface on two sides can be involved.

As a rule, the supporting surface forms no part of the transmitter/receiver to be manufactured. A favorable moment for removing the supporting surface from the transmitting and/or receiving layer is after step b and before step d.

In the following, the invention will be described in more detail with reference to the appended drawings, in which corresponding parts are designated by corresponding reference numerals, in which drawings:

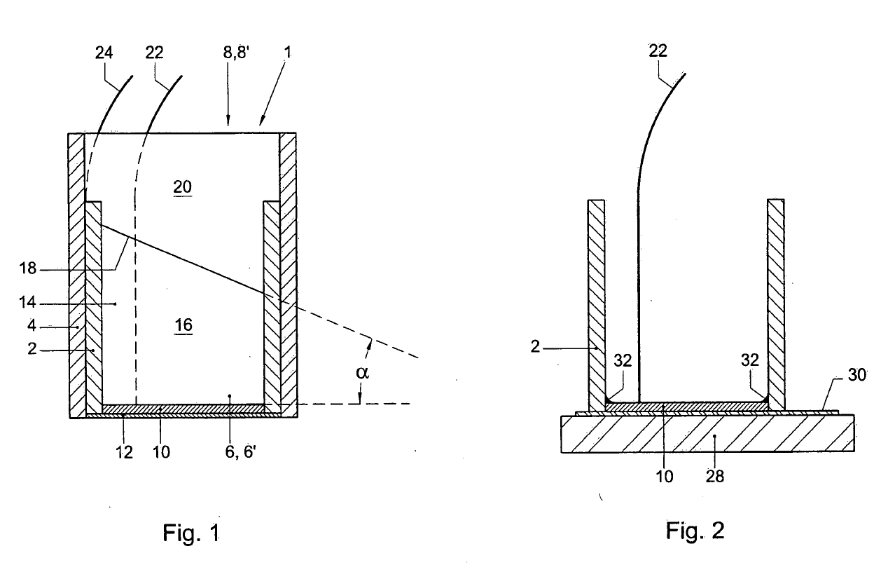

FIG. 1 shows a cross section of a transmitter/receiver obtained with the aid of an embodiment of the method according to the invention;

FIG. 2 shows a cross section of the transmitter/receiver of FIG. 1 after carrying out step a of the embodiment of the method according to the invention;

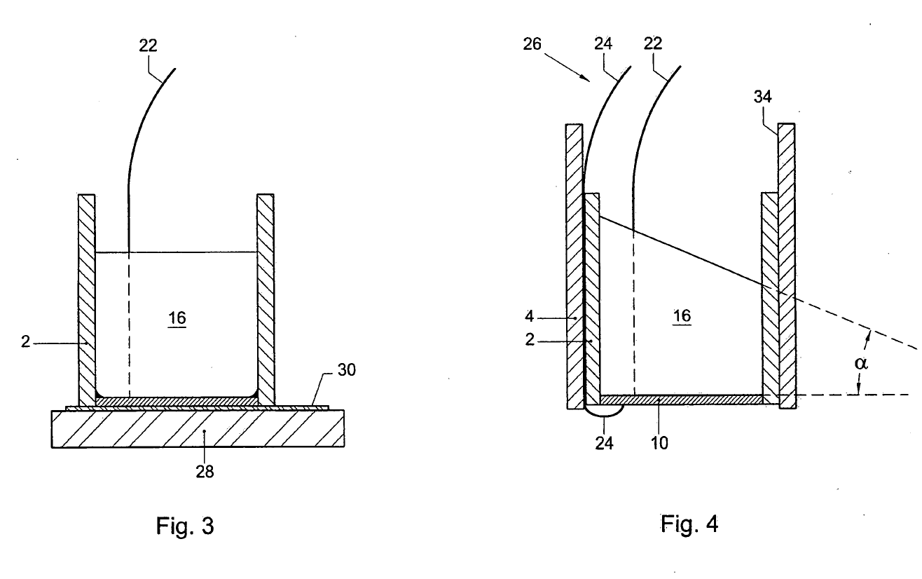

FIG. 3 shows a cross section of the transmitter/receiver of FIG. 1 after carrying out step b of the embodiment of the method according to the invention; and

FIG. 4 shows a cross section of the transmitter/receiver of FIG. 1 after carrying out step c of the method of an embodiment of the invention.

FIG. 1 shows a cross section of a transmitter/receiver 1 obtained with the aid of the method according to the invention. The transmitter/receiver 1 comprises an, in this embodiment, tubular inner and outer housing 2, 4. The inner housing 2 is, for instance, manufactured from a plastic, such as Celeron, and may have .a diameter of 12 millimeters. The outer housing 4 may be manufactured from a metal, such as stainless steel. In this embodiment of the invention, both the inner housing 2 and the outer housing 4 have a tubular design, each having a first and a second open end 6 and 6′ and 8 and 8′, respectively. Further, the transmitter/receiver 1 also comprises a transmitting and receiving layer, in this embodiment in the form of a piezo crystal 10, a layer 12 on a side of the piezo crystal 10 facing away from a space 14 enclosed by the inner housing 2 and the outer housing 4. Applying such a layer preferably takes place in vacuum, so that no undesired gases, such as air, are present in the epoxy. After this, the epoxy can cure and the layer can be finished by sanding. The layer may be a lambda layer. The layer may, for instance, have a thickness which corresponds to a quarter of waves to be transmitted or received by the apparatus. Such a layer is often called a ¼ lambda layer. The piezo crystal 10 completely seals off the inner housing 2. As a piezo crystal, for instance, K81 is very suitable material. In a portion of the space enclosed by the inner housing 2 and the outer housing 4 which is adjacent to the piezo crystal 10, a first material 16 is present which comprises, in this embodiment of the invention, both epoxy and tungsten and of which first material, in addition, a top surface 18 includes an angle a with the piezo crystal 10, which angle a serves to prevent resonance phenomena in the first material 16. Further, in this embodiment of the invention, in a portion of above-mentioned space adjacent to the first material 16, a second material 20 is present, for instance 2850FT—a form of epoxy. In this embodiment of the invention, a mass percentage of 20% 2850FT and 80% tungsten is used. FIG. 2 further shows a first wire 22 and a second, for instance silver wire 24 which, in this embodiment of the invention, form a wiring 26 (see FIG. 4) with which the piezo crystal 10 is operatively controlled and with which signals from the piezo crystal 10 are passed on. What is suitable as a second material 20 is, for instance, a resin, such as epoxy. Particularly 2850FT is very suitable as a second material 20.

In use, in this embodiment, by means of the wiring 26, signals are passed on to the piezo crystal 10, which converts the signals into acoustic vibrations which are passed on to an environment of the transmitter/receiver via the layer 12.

It is also possible that, in use, the piezo crystal 10 receives acoustic vibrations and converts them into a signal which is passed on via the wiring 26.

According to the invention, such a transmitter/receiver can be manufactured in the following manner.

Step a of the method of this embodiment of the method comprises, in this embodiment, placing the piezo crystal 10 in or on the inner housing 2 in a manner such that a side of the inner housing 2 is at least virtually sealed off by the piezo crystal 10. Here, for instance, use can be made of a supporting surface 28 (see FIGS. 2 and 3). The piezo crystal 10 is provided on the supporting surface with the aid of a tape 30. Preferably, this tape 30 has a self-adhesive surface on two sides. This embodiment of the invention further comprises, after step a, providing the first wire 22. After carrying out the method, the first wire 22 extends from a position on or in the piezo crystal 10 through the space enclosed by the inner housing 2 as far as outside this space. Further, in this embodiment of the method, with or after carrying out the first step, the piezo crystal 10 may be attached, near its edges, to the inner housing 2 with a third material 32. This third material 32 may, for instance, comprise epoxy or another suitable resin. Then, the transmitter/receiver 1 can be put in a vacuum for some time, for instance 2 minutes, to remove polluting gases from the third material.

Further, in FIG. 3, the transmitter/receiver 1 to be manufactured is shown after carrying out step b, while, in this embodiment, step b entails that the first material 16 is provided in the space enclosed by the inner housing 2, while the space is adjacent to the piezo crystal 10. Step b may, for instance, comprise pouring the first material in a vacuum, after which the transmitter/receiver is placed in an oven (not shown in the Figures). This may, for instance, take place by each time pouring layers of about 2 mm, while the first material is, each time, placed under a pressure of about 0.1 bar for about 1 minute, after which, optionally, a glass fiber mat (not shown in the Figures) can be placed on the layer of 2 mm.

It is preferred to remove, prior to carrying out step b, as much air as possible from other polluting gases by first vibrating the material 16. This may, for instance, take place under a pressure of 0.1 bar, for instance for 1 minute.

In order to, in addition, make the top surface 18 of the first material include the angle a with the piezo crystal, in this embodiment, after carrying out step b, the first material of the transmitter/receiver is allowed to stand in an inclined manner, so that the piezo crystal 10 is at angle unequal to 90° with the field of gravity.

Following the above, the supporting surface 28 and the tape 30 can be removed. Further, the second wire 24 can be provided, which second wire 24 is attached to a side of the piezo crystal 10 facing away from the space enclosed by the inner housing 2. Then, step c can be carried out by providing the outer housing 4 around the inner housing 2 (FIG. 4). In this embodiment, the inner housing 2 is completely enclosed by the outer housing 4. The outer housing 4 is provided in a manner such that the second wire 24 ends up between the inner housing 2 and de outer housing 4.

Preferably, further, a sealing layer, in this embodiment the ¼ lambda layer 12, is applied to the piezo crystal 10 on a side of the piezo crystal 10 facing away from the space enclosed by the inner housing 2, which space is also bounded by the outer housing 4 and the piezo crystal 10.

Finally, in this embodiment, then step d is carried out by pouring the second material 20 into the inner housing 2. This takes place in such a manner that the inner housing 2 overflows with the second material which then runs against an inner wall 34 of the outer housing 4, since the second open end 8′ of the outer housing 4 extends beyond the inner housing 2 (see FIGS. 1 and 4). Further, the second material 20 runs between the inner housing 2 and the outer housing 4. The pouring takes place in a vacuum, so that polluting gases can leave the second material 20. After the second material 16 running between the inner housing 2 and the outer housing 4 in a flowing condition, the second material 20 changes into a binding condition for the purpose of manufacturing a fixed connection between the inner housing 2 and the outer housing 4 by means of curing the second material. To this end, the transmitter/receiver 1 may optionally be placed in the oven.

As the pouring of the second material takes place in a vacuum, the space between the inner housing 2 and the outer housing 4 is filled better, so that, between the inner housing 2 and the outer housing 4, a good back pressure can be applied against the external pressure. Then, in the vacuum, gas pollutions simply leave the second material 20, which contributes to the capacity of applying a good back pressure.

After carrying out step d, the transmitter/receiver 1 of FIG. 1 is obtained.

It will be clear to a skilled person that the invention is not limited to the above-described embodiment of the invention. Thus, it is possible to carry out the steps a, b, c and d in a different order in an alternative embodiment. Thus, an embodiment is conceivable in which first step a, then step c, then step b and finally step d are carried out. Such embodiments are understood to fall within the framework of the invention.

1. A method for manufacturing a transmitter/receiver for transmitting/receiving acoustic waves, which method comprises at least the following steps:
a. placing a transmitting and/or receiving layer in or on an inner housing in a manner such that a side of the inner housing is at least virtually sealed off by the transmitting and/or receiving layer;
b. providing at least a first material in a space enclosed by the inner housing and the outer housing, which space is adjacent to the transmitting and/or receiving layer;
c. providing an outer housing around the inner housing, which outer housing encloses the inner housing at least partly after provision; and
d. providing a second material between the inner housing and the outer housing,
characterized in that, in step d, upon provision of the second material, through pouring, the second material runs in a vacuum between the inner housing and the outer housing for the purpose of manufacturing a fixed connection between the inner housing and the outer housing.

2. The method according to claim 1, characterized in that, when the second material runs between the inner housing and the outer housing, the second material has a flowing condition and then changes into a binding condition for the purpose of manufacturing a fixed connection between the inner housing and the outer housing.

3. The method according to claim 1 or characterized in that step d also comprises pouring the second material into at least a part of the inner housing and then curing the second material, wherein step d is carried out after step c.

4. The method according to claim 1, characterized in that, upon pouring the second material, the inner housing overflows in a manner such that the second material also runs between the inner housing and the outer housing, wherein step d is carried out after steps b and c.

5. The method according to claim 1, characterized in that the method also comprises the following step:
e. vibrating the first material for removing polluting gases from the first material.

6. The method according to claim 1, characterized in that, after carrying out step b and before carrying out step d, the method further comprises the following step:
f. positioning the inner housing, the outer housing and the transmitting and/or receiving layer relative to the top surface of the first material in a manner such that the top surface includes an angle with the transmitting and/or receiving layer.

7. The method according to claim 6, characterized in that step f further comprises curing the first material while the top surface includes the said angle.

8. The method according to claim 1, characterized in that the method further comprises the following step:
g wiring the transmitting and/or receiving by means of wiring for controlling the transmitting and/or receiving layer and/or passing on received signals from the transmitting and/or receiving layer.

9. The method according to claim 8, characterized in that step g, prior to carrying out steps b and d, comprises providing at least one first wire, which first wire is attached to a side of the transmitting and receiving layer which is adjacent to the space enclosed by the inner housing and the outer housing and which extends through this enclosed space in a direction away from the transmitting and receiving layer as far as outside the space.

10. The method according to claim 8, characterized in that step g, prior to carrying out steps c and d, comprises providing at least one second wire, which second wire is attached to a side of the receiving and/or receiving layer located on a side facing away from the space enclosed by the inner housing and the outer housing.

11. The method according to claim 1, characterized in that the first material comprises a resin.

12. The method according to claim 11, characterized in that the resin is an epoxy.

13. The method according to claim 1, characterized in that the first material comprises a metal.

14. The method according to claim 12, characterized in that the metal is tungsten.

15. The method according to claim 1, characterized in that the second material comprises a resin.

16. The method according to claim 15, characterized in that the resin is epoxy.

17. The method according to claim 1, characterized in that the method also comprises applying a layer, for instance a lambda layer, in particular a ¼ lambda layer, to the transmitting and/or receiving layer on a side of the transmitting and/or receiving layer facing away from the space enclosed by the inner housing and the outer housing.

18. The method according to claim 1, characterized in that the transmitting and/or receiving layer comprises a piezo crystal.

19. The method according to claim 1, characterized in that the transmitting and/or receiving layer is provided on a supporting surface prior to carrying out step a.

20. The method according to claim 19, characterized in that the transmitting and/or receiving layer is provided on the supporting surface with the aid of a tape.

21. The method according to claim 20, characterized in that the tape has a self-adhesive surface on two sides.

22. The method according to claim 19, characterized in that the supporting surface is removed after step b and prior to step d.

23. The method according to claim 1, characterized in that, in step a, an open side of the inner housing is at least virtually sealed off by the transmitting and/or receiving layer.

24. The method according to claim 1, characterized in that the inner housing has a tubular design.

25. The method according to claims 23, characterized in that the inner housing is provided with a first and second open end, wherein the first open end forms the said open side.

26. The method according to claim 25, characterized in that, in step b, through the second open end, the first material is introduced into the space enclosed by the inner housing and the outer housing, which space is adjacent to the transmitting and/or receiving layer.

27. The method according to claim 24, characterized in that the outer housing also has a tubular design and comprises a first and second open end.

28. The method according to claim 25, characterized in that, at the second open end of the inner housing, the outer housing extends beyond the inner housing.

29. The method according to claim 17, characterized in that the layer is included in a space bounded by the outer housing and the layer.

30. The method according to claim 1, characterized in that, in step a, the layer is, near its edges, attached to the inner housing with a third material.

31. The method according to claim 30, characterized in that the third material comprises a resin such as epoxy.

32. The method according to claim 1, characterized in that step d is carried out after step c, step c after step b and step b after step a.

33. The method according to claim 1, characterized in that step d is carried out after step b, step b after step c and step c after step a.

34. The method according to claim 10, characterized in that, in step c and prior to step d, the second wire is provided in a manner such that it extends further between the inner housing and the outer housing.

35. The apparatus obtained by means of use of a method according to claim 1.
